(19) United States
(12) Patent Application Publication
(10) Pub. No.: US 2023/0392403 A1
(43) Pub. Date: Dec. 7, 2023

(54) VEHICLE PARKING ROBOT AND VEHICLE PARKING METHOD

(71) Applicant: HL Mando Corporation, Pyeongtaek-si (KR)

(72) Inventors: WanKyu CHOI, Seongnam-si (KR); Joon-Kyu SONG, Seongnam-si (KR); SeongHo CHOI, Anyang-si (KR)

(21) Appl. No.: 18/204,540

(22) Filed: Jun. 1, 2023

(30) Foreign Application Priority Data
Jun. 2, 2022 (KR) 10-2022-0067391

(51) Int. Cl. E04H 6/36; B66F 9/075; B66F 9/06; G06V 20/58; G06T 7/70

(52) U.S. Cl. CPC E04H 6/36; B66F 9/0755; B66F 9/063; G06V 20/586; G06T 7/70; G06T 2207/30264; H04N 23/90

(57) ABSTRACT

A vehicle parking robot includes: a first robot including a first body provided with a first rail, a first front fork that moves along the first rail, a first rear fork that moves along the first rail, and a first electric wheel that provides a driving force; a first camera that captures an image of the first vehicle wheel and collects first image information; and a first controller that identifies the first vehicle wheel from the first image information, and controls the first front fork, the first rear fork, and the first electric wheel. The vehicle parking robot lifts the vehicle from the ground, and places the vehicle in a parking space.

### CROSS-REFERENCE TO RELATED APPLICATIONS

This application is based on and claims priority from Korean Patent Application No. 10-2022-0067391, filed on Jun. 2, 2022, with the Korean Intellectual Property Office, the disclosure of which is incorporated herein in its entirety by reference.

### TECHNICAL FIELD

The present disclosure relates to a vehicle parking robot and a vehicle parking method, more particularly, a vehicle parking robot and a vehicle parking method, which park a vehicle by loading the vehicle.

### BACKGROUND

Vehicles are a common mode of transportation in modern society, and their usage is continuously on the rise. The increase in usage of vehicles has resulted in a shortage of parking spaces for storing vehicles when the vehicles are not in use.

As a result, parking spaces in and around densely populated cities are increasingly limited in size in order to accommodate more vehicles in a more efficient manner.

Even when designing a small parking space, a minimum amount of space is required to allow a driver to park his/her vehicle and exit the parking space with the vehicle. Thus, there are limitations to how small a parking space can be designed.

Further, parking in a small space generally requires a high level of skill from the driver, and in the end, an unskilled driver attempting to park in such a small space may cause serious or minor accidents.

Recently, mechanical parking facilities have been developed to provide parking spaces and accommodate vehicles in a dense manner without requiring a high level of skill from the driver.

### SUMMARY

According to an aspect of the present disclosure, a vehicle parking robot includes: a first robot including a first body provided with a first rail that extends longitudinally, a first front fork coupled to the first rail and configured to move along the first rail and support a first side of a first vehicle wheel of a vehicle, the first vehicle wheel rotating about a first rotation axis, a first rear fork coupled to the first rail and configured to move along the first rail and support a second side of the first vehicle wheel, and a first electric wheel disposed on the first body and configured to provide a driving force; a first camera disposed on the first body to face a lateral surface of the first vehicle wheel and configured to capture an image of the first vehicle wheel and collect first image information; and a first controller configured to identify the first vehicle wheel from the first image information, and control the first front fork, the first rear fork, and the first electric wheel. The vehicle parking robot lifts the vehicle from a ground, and places the vehicle in a parking space.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a configuration diagram of a vehicle parking robot according to an embodiment of the present disclosure.

FIG. 2 is a perspective view of the vehicle parking robot according to an embodiment of the present disclosure.

FIG. 3 is a top view of the vehicle parking robot according to an embodiment of the present disclosure.

FIG. 4 is a view illustrating first image information obtained from a first camera of the vehicle parking robot according to an embodiment of the present disclosure.

FIG. 5 is a front view of a sensing area of a first obstacle recognition sensor of the vehicle parking robot according to an embodiment of the present disclosure.

FIG. 6 is a right-side view of sensing areas of the first obstacle recognition sensor and a second obstacle recognition sensor of the vehicle parking robot according to an embodiment of the present disclosure.

FIG. 7 is a flowchart of a vehicle parking method according to an embodiment of the present disclosure.

FIG. 8 is a flowchart of a first fork positioning step of the vehicle parking method according to an embodiment of the present disclosure.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

In the conventional mechanical parking facilities, the driver is still required to maneuver his/her vehicle into a designated area within the mechanical parking facilities, necessitating a certain level of driving skill from the driver.

Further, the mechanical parking facilities often restrict the size of vehicles that can be parked, and therefore, do not resolve the primary problem for securing parking spaces.

Accordingly, there has been a growing demand for developing a parking assist equipment that may provide a high compatibility with respect to the size of a vehicle while utilizing existing parking spaces as densely as possible, and does not require a high level of parking skill from the driver.

The present disclosure has been made to solve the problems described above, and its object is to provide a vehicle parking robot and a vehicle parking method, which are capable of parking a vehicle regardless of a type of vehicle.

Further, the present disclosure provides a vehicle parking robot and a vehicle parking method, which are capable of parking a vehicle after safely loading the vehicle.

The problems sought to be solved by the present disclosure are not limited to those aforementioned, and other problems that are not set forth herein may be clearly understood by those skilled in the art from the descriptions herein below.

According to an aspect of the present disclosure, a vehicle parking robot includes: a first robot including a first body provided with a first rail that extends longitudinally, a first front fork coupled to the first rail and configured to move along the first rail and support a first side of a first vehicle wheel of a vehicle, the first vehicle wheel rotating about a first rotation axis, a first rear fork coupled to the first rail and configured to move along the first rail and support a second side of the first vehicle wheel, and a first electric wheel disposed on the first body and configured to provide a driving force; a first camera disposed on the first body to face a lateral surface of the first vehicle wheel and configured to capture an image of the first vehicle wheel and collect first image information; and a first controller configured to identify the first vehicle wheel from the first image information, and control the first front fork, the first rear fork, and the first electric wheel. The vehicle parking robot lifts the vehicle from a ground, and places the vehicle in a parking space.

The first controller controls the first electric wheel to position the first front fork at the first side of the first vehicle wheel identified from the first image information, and the first rear fork at the second side of the first vehicle wheel.

The first controller controls the first electric wheel to position a front end of the first front fork and a front end of the first rear fork at the lateral surface of the first vehicle wheel, and then to move the first front fork and the first rear fork in a first direction in which the first rotation axis of the first vehicle wheel extends, to insert the first front fork and the first rear fork under the vehicle.

The vehicle parking robot may further include: a first front obstacle recognition sensor disposed at an end of the first front fork; and a first rear obstacle recognition sensor disposed at an end of the first rear fork.

The vehicle may further include a second vehicle wheel configured to rotate about a second rotation axis parallel to the first rotation axis, and the vehicle parking robot may further include: a second robot including a second body provided with a second rail that extends longitudinally, a second front fork coupled to the second rail and configured to move along the second rail and support a first side of the second vehicle wheel, a second rear fork coupled to the second rail and configured to move along the second rail and support a second side of the second vehicle wheel, and a second electric wheel disposed on the second body and configured to provide a driving force; and a second controller configured to receive a control signal from the first controller to control the second front fork, the second rear fork, and the second electric wheel.

The first controller transmits first distance information between the first vehicle wheel and the second vehicle wheel to the second controller, in which the first distance information is calculated by further identifying the second vehicle wheel from the first image information. The second controller controls the second electric wheel based on the first distance information to position the second front fork at the first side of the second vehicle wheel identified from the first image information, and the second rear fork at the second side of the second vehicle wheel.

When the first controller does not identify the first vehicle wheel and the second vehicle wheel from the first image information, the first controller controls the first electric wheel to move the first camera from the vehicle by a predetermined distance, and the first camera re-captures an image of the first vehicle wheel and the second vehicle wheel to collect the first image information.

The first controller controls the first electric wheel to position a front end of the first front fork and a front end of the first rear fork at the lateral surface of the first vehicle wheel, and then move the first front fork and the first rear fork in a first direction in which the first rotation axis of the first vehicle wheel extends, to insert the first front fork and the first rear fork under the vehicle. Further, the second controller controls the second electric wheel to position a front end of the second front fork and a front end of the second rear fork at a lateral surface of the second vehicle wheel, and then move the second front fork and the second rear fork in a second direction in which the second rotation axis of the second vehicle wheel extends, to insert the second front fork and the second rear fork under the vehicle.

The vehicle parking robot may further include: a second camera disposed on the second body to face a lateral surface of the second vehicle wheel, and configured to capture an image of the second vehicle wheel and collect second image information. The second controller transmits second distance information between the first vehicle wheel and the second vehicle wheel to the first controller, in which the second distance information is calculated by identifying the first vehicle wheel and the second vehicle wheel from the second image information. The first controller compares the first distance information and the second distance information to verify whether the first distance information matches the second distance information, and determines whether to load the vehicle.

The vehicle parking robot may further include: a host controller configured to store third distance information between the first vehicle wheel and the second vehicle wheel of the vehicle, and communicate with the first controller.

The first controller compares the first distance information with the third distance information to verify whether the first distance information matches the third distance information, and determines whether to load the vehicle, in which the first distance information is calculated by identifying the first vehicle wheel and the second vehicle wheel from the first image information.

When the first distance information does not match the third distance information, the first controller further compares the first distance information with the second distance information to verify whether the first distance information matches the second distance information, and determines whether to load the vehicle.

According to another aspect of the present disclosure, a vehicle parking method includes: a vehicle parking robot providing step for providing a vehicle parking robot configured to lift a vehicle from a ground and place the vehicle in a parking space, in which the vehicle includes a first vehicle wheel rotating about a first rotation axis and a second vehicle wheel rotating about a second rotation axis parallel to the first rotation axis; a first image information collecting step for collecting first image information by capturing an image of the first vehicle wheel by a first camera; a first image information analyzing step for identifying the first vehicle wheel from the first image information; a first fork positioning step for positioning a first front fork at a first side of the first vehicle wheel and a first rear fork at a second side of the first vehicle wheel, by a first controller, based on a position of the first vehicle wheel identified from the first image information; and a first vehicle wheel loading step for lifting the first vehicle wheel with the first front fork and the first rear fork.

The first fork positioning step may include: a front-end-of-first-fork positioning step for controlling, by the first controller, a first electric wheel to position a front end of the first front fork and a front end of the first rear fork at a lateral surface of the first vehicle wheel; and a first fork inserting step for moving, by the first controller, the first front fork and the first rear fork in a first direction in which the first rotation axis of the first vehicle wheel extends, to insert the first front fork and the first rear fork under the vehicle.

In the first vehicle wheel loading step, the first front fork and the first rear fork move closer together about the first rotation axis of the first vehicle to lift the first vehicle wheel from the ground.

In the first image information collecting step, the first camera captures an image of the first vehicle wheel and the second vehicle wheel to collect the first image information. In the first image information analyzing step, the first vehicle wheel and the second vehicle wheel are identified from the first image information. The vehicle parking method may further include: a second fork positioning step for positioning, by a second controller, a second front fork at a first side of the second vehicle wheel and a second rear fork at a second side of the second vehicle wheel, based on first distance information between the first vehicle wheel and the second vehicle wheel that are identified from the first image information received from the first controller; and a second vehicle wheel loading step for lifting the second vehicle wheel with the second front fork and the second rear fork.

In the first image information collecting step, when the first controller does not identify the first vehicle wheel and the second vehicle wheel from the first image information, the first controller controls a first electric wheel to move the first camera from the vehicle by a predetermined distance, and the first camera re-captures an image of the first vehicle wheel and the second vehicle wheel to collect the first image information.

The vehicle parking method may further include: prior to the second fork positioning step, a second image information collecting step for collecting second image information by capturing an image of the first vehicle wheel and the second vehicle wheel by a second camera; a second image information analyzing step for identifying the first vehicle wheel and the second vehicle wheel from the second image information; and a first verification step for transmitting, by the second controller, second distance information between the first vehicle wheel and the second vehicle wheel to the first controller, in which the second distance information is calculated by identifying the first vehicle wheel and the second vehicle wheel from the second image information, and comparing, by the first controller, the first distance information and the second distance information to verify whether the first distance information matches the second distance information. In the second fork positioning step, when the first distance information matches the second distance information, the second controller receives a control signal from the first controller to control the second front fork and the second rear fork.

The vehicle parking method may further include: prior to the second fork positioning step, a second verification step for receiving, by the first controller, third distance information between the first vehicle wheel and the second vehicle wheel from a host controller, and comparing, by the first controller, the third distance information with the first distance information to verify whether the first distance information matches the third distance information. In the second fork positioning step, when determined in the second verification step that the first distance information matches the third distance information, the second controller receives a control signal from the first controller to control the second front fork and the second rear fork.

In the second fork positioning step, when determined in the second verification step that the first distance information matches with the second distance information, but not with the third distance information, the second controller receives a control signal from the first controller to control the second front fork and the second rear fork.

The vehicle parking robot and the vehicle parking method according to the embodiments of the present disclosure measure the distance between the first and second vehicle wheels of the vehicle and load the first and second vehicle wheels, so that the vehicle may be parked regardless of the type of vehicle.

Further, the vehicle parking robot and the vehicle parking method according to the embodiments of the present disclosure measure the distance between the first and second vehicle wheels by using multiple methods for verification, so that the vehicle may be parked after being safely loaded.

The effects of the present disclosure are not limited to those described above, but should be construed as including all effects that may be inferred from the description of the present disclosure herein or the configuration of the disclosure described in the claims.

Hereinafter, with reference to the accompanying drawings, the embodiments of the present disclosure will be described in detail such that one skilled in the art may easily practice the embodiments. The present disclosure may be embodied in many different forms, and is not limited to the embodiments described herein. In order to clearly describe the present disclosure, the drawings omit parts irrelevant to the description of the present disclosure, and the same or similar components throughout the description herein will be denoted by the same reference numerals.

Words and terms used in the detailed description and the claims herein should not be interpreted to be limited to their usual or dictionary meanings, but should be interpreted to have meanings and concepts that correspond to the technical idea of the present disclosure in compliance with the principle that inventors may define terms and concepts for the purpose of best describing the disclosure.

Since the embodiments described herein and the configuration illustrated in the drawings merely correspond to certain embodiments of the present disclosure, and do not completely represent all the technical idea of the present disclosure, various equivalents or modifications may be made to substitute the embodiments and the configuration at the time of the filing of the present disclosure.

In the present description, terms such as “include” and “have” are intended to describe the presence of features, numerals, steps, operations, components, parts, or combinations thereof described herein, and should not be construed as excluding the presence or addition of one or more other features, numerals, steps, operations, components, parts, or combinations thereof.

Unless otherwise specified, a description that a component is present at a “front,” “rear,” “upper,” or “lower” side of another component includes not only a case where a component is directly disposed at the “front,” “rear,” “upper,” or “lower” side of another component, but also a case where a component is disposed at the “front,” “rear,” “upper,” or “lower” side of another component via still another component. Further, unless otherwise specified, a description that a component is “connected” to another component includes not only a case where the two components are directly connected to each other, but also a case where the two components are indirectly connected to each other.

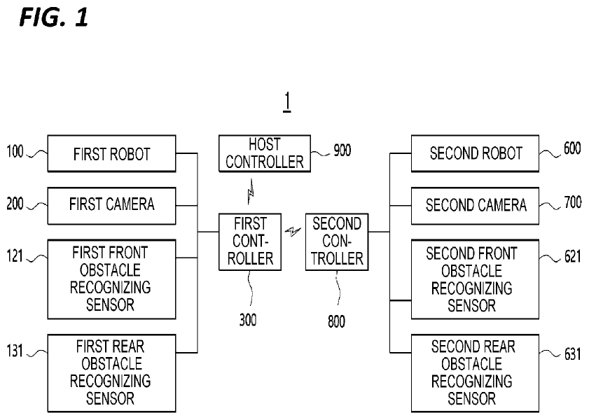

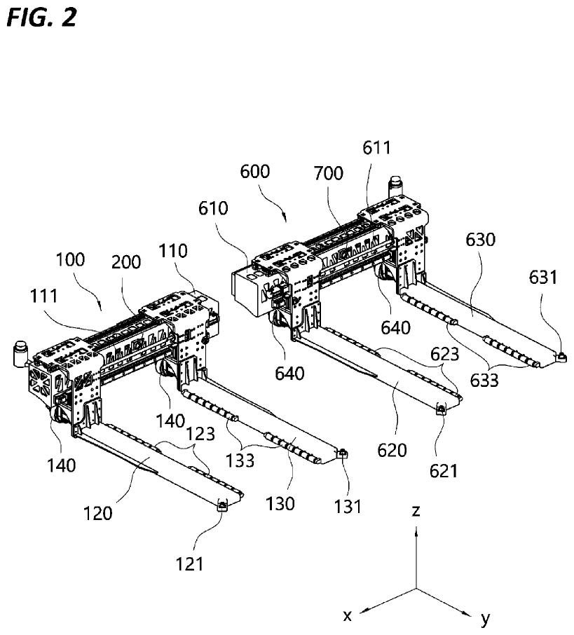

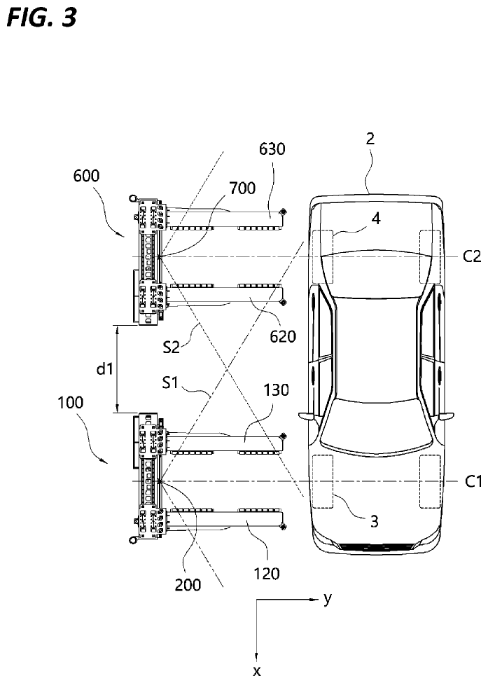

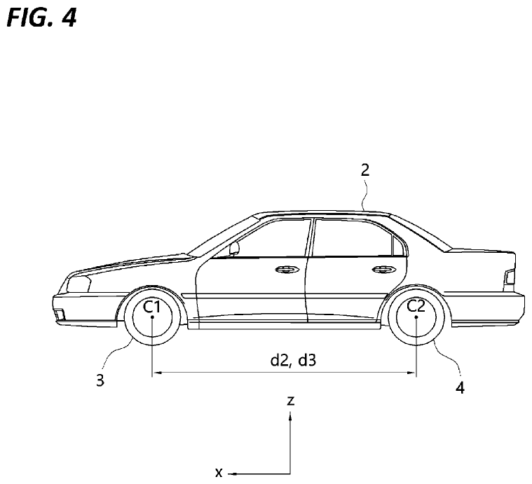

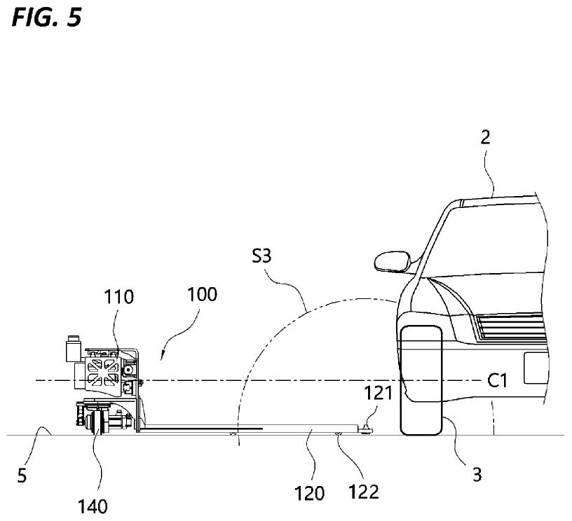

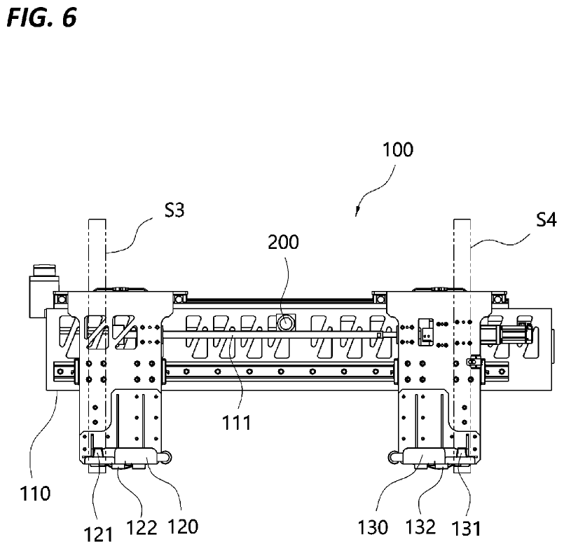

FIG. 1 is a configuration diagram of a vehicle parking robot according to an embodiment of the present disclosure. FIG. 2 is a perspective view of the vehicle parking robot according to the embodiment of the present disclosure. FIG. 3 is a top view of the vehicle parking robot according to the embodiment of the present disclosure. FIG. 4 is a view illustrating first image information obtained from a first camera of the vehicle parking robot according to the embodiment of the present disclosure. FIG. 5 is a front view of a sensing area of a first obstacle recognition sensor of the vehicle parking robot according to the embodiment of the present disclosure. FIG. 6 is a right-side view of sensing areas of the first obstacle recognition sensor and a second obstacle recognition sensor of the vehicle parking robot according to the embodiment of the present disclosure. Hereinafter, descriptions will be made assuming that in FIG. 2, the direction of the X-axis is a forward direction, the direction of the Y-axis is a leftward direction, and the direction of the Z-axis is an upward direction.

According to an embodiment of the present disclosure, a vehicle parking robot 1 lifts a vehicle 2 from the ground 5, and places (e.g., parks) the vehicle 2 in a designated parking space. The vehicle 2 may include a first vehicle wheel 3 and a second vehicle wheel 4.

The first vehicle wheel 3 and the second vehicle wheel 4 rotate about a first rotation axis C1 and a second rotation axis C2, respectively, to provide a driving force to the vehicle 2. At this time, when the vehicle 2 is in a straight state, the first rotation axis C1 and the second rotation axis C2 are arranged in parallel to each other.

Each of the first vehicle wheel 3 and the second vehicle wheel 4 is configured with a pair of wheels. The pair of first vehicle wheels 3 are arranged side by side to be rotatable about the first rotation axis C1. Similarly, the pair of second vehicle wheels 4 are arranged side by side to be rotatable about the second rotation axis C2.

Each first vehicle wheel 3 and each second vehicle wheel 4 may be arranged in a row in the front-rear direction. That is, the first vehicle wheel 3 and the second vehicle wheel 4 that are disposed on the left side may be arranged in a row at a predetermined interval, and the first vehicle wheel 3 and the second vehicle wheel 4 that are disposed on the right side may be arranged in a row at a predetermined interval.

The type of vehicle 2 is not limited as long as the vehicle 2 may receive the driving force from the first vehicle wheel 3 and the second vehicle wheel 4 as described above, and move forward or backward according to the rotation direction of the first vehicle wheel 3 and the second vehicle wheel 4.

In order to park the vehicle 2 without a human directly driving the vehicle 2, the vehicle parking robot 1 according to the embodiment of the present disclosure includes a first robot 100, a first camera 200, and a first control unit 300 as illustrated in FIG. 1.

As illustrated in FIG. 2, the first robot 100 may move in the direction in which the rotation axis of the pair of first vehicle wheels 3 of the vehicle 2 extends, and lift the pair of first vehicle wheels 3.

As illustrated in FIG. 2, the first robot 100 of the vehicle parking robot 1 according to the embodiment of the present disclosure includes a first body 110, a first rail 111, a first front fork 120, a first rear fork 130, and a first electric wheel 140.

As illustrated in FIG. 2, the first rail 111 is provided in the first body 110 to extend in the front-rear direction. The shape of the first body 110 is not limited as long as the first rail 111 may be provided in the first body 110. For example, the first body 110 may have a rectangular parallelepiped frame structure.

The first rail 111 may be provided on the left or upper surface of the first body 110. Furthermore, a plurality of first rails 111 may be provided on the left and upper surfaces of the first body 110. In the present embodiment, a single first rail is provided on the left surface of the first body 110.

The first front fork 120 is coupled to the first rail 111 of the first body 110. The first front fork 120 is coupled to the first rail 111 to be movable back and forth. The first front fork 120 is positioned at the front side of the first vehicle wheel 3, and supports the front side of the first vehicle wheel 3.

The terms “front” and “rear” included in the names of components are merely intended to discriminate the components, similar to the one side and the other side of a wheel, and are not intended to limit the orientations or directions.

There is no limitation on how to couple the first rail 111 and the first front fork 120, as long as the first front fork 120 may be guided and moved on the first rail 111 without deviating from the first rail 111.

The movement of the first front fork 120 along the first rail 111 is controlled by the first control unit 300 to be described later. The driving force that allows the first front fork 120 to be guided and moved along the first rail 111 may be provided by a separate motor or by the first electric wheel 140. Details thereof will be described later.

As illustrated in FIG. 2, the first front fork 120 extends leftward. The extension length of the first front fork 120 may vary depending on the design. For example, the extension length of the first front fork 120 may be formed longer than the maximum left-right width of the vehicle 2 that may be parked in a given parking environment. Accordingly, the first front fork 120 may support both of the pair of first vehicle wheels 3 of the vehicle 2.

As illustrated in FIG. 5, as the first robot 100 moves leftward, the first front fork 120 may be inserted between the underside of the vehicle 2 and the ground 5 of the parking lot, until the first front fork 120 is finally positioned in front of the pair of first vehicle wheels 3.

In a state of being positioned in front of the first vehicle wheels 3 of the vehicle 2, the first front fork 120 is controlled by the first control unit 300, which will be described later, to move rearward and come into contact with the front sides of the first vehicle wheels 3. At this time, the first rear fork 130 to be described later also moves forward.

In a state where the front sides of the first vehicle wheels 3 are supported by the first front fork 120, and the rear sides of the first vehicle wheels 3 are supported by the first rear fork 130, the first front fork 120 and the first rear fork 130 move closer together until the first vehicle wheels 3 are raised off the ground 5 of the parking lot. As a result, the first robot 100 lifts the first vehicle wheels 3 of the vehicle 2.

As illustrated in FIG. 2, the first electric wheel 140 is coupled to the first front fork 120, and disposed below the lower surface of the first body 110. The first electric wheel 140 provides an independent rotation driving force. Thus, the first robot 100 may move on the ground 5 of the parking lot by the first electric wheel 140 controlled by the first control unit 300.

The first electric wheel 140 is disposed such that the rotation axis of the wheel is parallel to the ground 5 of the parking lot, and may rotate 360° about a rotation axis extending along the upward-downward direction such that the movement direction of the first robot 100 may be controlled at its current position. As a result, the first robot 100 may change the direction of movement thereof without turning.

Further, since the first electric wheel 140 is fixed to the first front fork 120, it may provide the power for moving the first front fork 120 along the first rail 111. As a result, even though the first robot 100 does not include a separate motor for moving the first front fork 120, the first electric wheel 140 alone may be capable of both controlling the position of the first robot 100 and loading the first vehicle wheels 3 by the first front fork 120. That is, by simplifying the first robot 100 and reducing the number of components, the manufacturing cost and time may be reduced in the present disclosure.

As for the first electric wheel 140, a known component may be used as long as the component is capable of providing the rotation driving force, and the shape of the first electric wheel 140 is not limited. For example, in order to minimize the size of the first robot 100, the first electric wheel 140 may be equipped with an in-wheel motor for providing the rotation driving force.

As illustrated in FIGS. 5 and 6, a first front auxiliary wheel 122 may be provided on the lower surface of the front end of the first front fork 120. The first front auxiliary wheel 122 prevents the first front fork 120 from touching the ground 5 of the parking lot and impeding the movement of the first robot 100, when the first robot 100 moves by the driving force from the first electric wheel 140.

The first front auxiliary wheel 122 does not provide a separate rotation driving force. That is, the movement of the first robot 100 is controlled only by the first electric wheel 140. Therefore, the need for expensive components for providing the rotation driving force is minimized, thereby reducing the manufacturing cost in the present disclosure.

The first front auxiliary wheel 122 is disposed such that the rotation axis of the wheel is parallel to the ground 5 of the parking lot, and may rotate in all directions about a vertically extending rotation axis. Accordingly, the first front auxiliary wheel 122 does not interfere with the movement of the first electric wheel 140.

In the first front fork 120, a first front support member 123 may be disposed. The first front support member 123 is disposed at the rear side of the first front fork 120 to face the first rear fork 130.

The first front support member 123 is a roller rotating about a rotation axis extending in the left-right direction such that the first vehicle wheel 3 is easily lifted by the first front fork 120 and the first rear fork 130 as the first front fork 120 moves rearward while being positioned at the front side of the first vehicle wheel 3.

Accordingly, the first vehicle wheel 3 comes into contact with the first front support member 123, and the friction force between the first vehicle wheel 3 and the first front support member 123 causes the first front support member 123 to rotate, so that the first vehicle wheel 3 may be easily lifted by the first front fork 120 and the first rear fork 130 and may remain in a state of being spaced apart from the ground 5 of the parking lot.

As illustrated in FIGS. 2 and 3, the first rear fork 130 is disposed behind the first front fork 120. Accordingly, the first rear fork 130 may be disposed facing the first front fork 120 with the first vehicle wheel 3 being interposed therebetween.

As illustrated in FIGS. 2 and 6, the first rear fork 130, a first rear auxiliary wheel 132, and a first rear support member 133 correspond to the first front fork 120, the first front auxiliary wheel 122, and the first front support member 123, respectively, described above, and the description of structures or functions thereof will be substituted with the description of the first front fork 120 within the overlapping scope. Hereinafter, descriptions will be made focusing on the differences of the first rear fork 130, the first rear auxiliary wheel 132, and the first rear support member 133 from the first front fork 120, the first front auxiliary caser 122, and the first front support member 123, respectively.

As illustrated in FIG. 2, the first rear fork 130 is disposed behind the first front fork 120, and coupled to the first rail 111 to be movable back and forth. The first rear fork 130 supports the pair of first vehicle wheels 3, in cooperation with the first front fork 120. The first rear fork 130 supports the rear sides of the pair of first vehicle wheels 3.

As illustrated in FIG. 2, a first electric wheel 140 is additionally disposed below the lower surface of the first body 110 while being coupled to the first rear fork 130. The added first electric wheel 140 may control the movement of the first rear fork 130 that is guided by the first rail 111. Thus, the first front fork 120 and the first rear fork 130 are controlled by the first electric wheels 140 at the front side and the rear side of the first vehicle wheel 3, respectively, so as to lift the first vehicle wheel 3.

As illustrated in FIGS. 2 and 3, the first camera 200 is disposed on the left surface of the first body 110 to face the right surface of the vehicle 2. The position where the first camera 200 is disposed is not limited. In the present embodiment, the first camera 200 is disposed at the center of the left surface of the first body 110 to prevent the position of the first camera 200 from changing even when the first front fork 120 and the first rear fork 130 move symmetrically forward and rearward.

As illustrated in FIG. 3, the first camera 200 captures the image of the right surface of the vehicle 2. At this time, a first area S1 captured by the first camera 200 includes the first vehicle wheel 3. That is, as illustrated in FIG. 4, first image information obtained from the first camera 200 includes the shape of the first vehicle wheel 3.

Meanwhile, when a second robot 600 to be described later is included, the first image information obtained from the first camera 200 may include the shape of the second vehicle wheel 4. As for the first camera 200, various types of known equipment may be used as long as the equipment may generate data from visual information and store the generated data.

The viewing angle of the first camera 200 may vary depending on its specifications and setting. Accordingly, the first area S1 captured by the first camera 200 may not include the shape of the right surface of the second vehicle wheel 4.

In this case, the first control unit 300 controls the first electric wheels 140 to move the first camera 200 further away from the vehicle 2 by a predetermine distance. That is, when the viewing angle of the first camera 200 is fixed, the first control unit 300 adjusts the distance between the first camera 200 and the vehicle 2. As a result, as illustrated in FIG. 3, the first area S1 includes the right surfaces of both the first vehicle wheel 3 and the second vehicle wheel 4, allowing the first image information to include the shapes of the first vehicle wheel 3 and the second vehicle wheel 4.

When the first area S1 includes both the first vehicle wheel 3 and the second vehicle wheel 4, the first camera 200 re-captures the image of the first area S1 to collect the first image information.

Although not illustrated in the drawings, the first control unit 300 may be disposed inside the first body 110 of the first robot 100. As illustrated in FIG. 1, the first control unit 300 is connected to the first robot 100, the first camera 200, and a first front obstacle recognition sensor 121 and a first rear obstacle recognition sensor 131 which will be described later, and collects information from the sensors to control the first robot 100 and the first camera 200.

As illustrated in FIG. 4, the first control unit 300 identifies the first vehicle wheel 3 from the first image information. When the first vehicle wheel 3 is identified, the first control unit 300 controls the first electric wheels 140 to position the first body 110 on the right side of the first vehicle wheel 3 such that the front ends of the first front fork 120 and the first rear fork 130 are positioned on the right side of the first vehicle wheel 3.

At this time, the first front fork 120 and the first rear fork 130 are positioned at the front end and the rear end of the first rail 111, before loading the first vehicle wheel 3. The initial distance between the first front fork 120 and the first rear fork 130 is formed to be larger than the diameter of a wheel of a typical vehicle available on the market. Thus, the first control unit 300 does not need to calculate the initial distance between the first front fork 120 and the first rear fork 130 according to the size of the first vehicle wheel 3.

When the first control unit 300 identifies the first vehicle wheel 3, the first control unit 300 inserts the first front fork 120 to be positioned at the front side of the first vehicle wheel 3 and the first rear fork 130 to be positioned at the rear side of the first vehicle wheel 3, under the vehicle 2. Then, the first front fork 120 and the first rear fork 130 are positioned at the front sides and the rear sides of both the pair of first vehicle wheels 3.

As the first front fork 120 and the first rear fork 130 positioned at the front sides and the rear sides of the pair of first vehicle wheels 3, respectively, move rearward and forward, respectively, the first vehicle wheels 3 are loaded on the first front fork 120 and the first rear fork 130, that is, on the first robot 100.

Meanwhile, as illustrated in FIG. 2, the vehicle parking robot 1 according to the embodiment of the present disclosure may further include the first front obstacle recognizing sensor 121 and the first rear obstacle recognition sensor 131.

The first front obstacle recognition sensor 121 is disposed at the end of the first front fork 120 to detect whether an obstacle is present on the movement path of the first front fork 120 that is being inserted under the vehicle 2.

As for the first front obstacle recognizing sensor 121, any of various known sensors may be used as long as the sensor may detect an obstacle on the movement path of the front end of the first front fork 120 that is being inserted under the vehicle 2. In the present embodiment, it is assumed that a two-dimensional lidar is used as the first front obstacle recognition sensor 121.

As illustrated in FIGS. 5 and 6, the first front obstacle recognition sensor 121 detects the presence of an obstacle within a third area S3, which is a two-dimensional area parallel to the plane perpendicular to the extending direction of the first rail 111.

When the first front obstacle recognition sensor 121 detects an obstacle, the first control unit 300 receives information of the obstacle, and prevents the first front fork 120 from moving toward the underneath of the vehicle.

At this time, the first control unit 300 compares the information of the first vehicle wheel 3 captured by the first camera 200 with the information detected by the first front obstacle recognition sensor 121, and when the first vehicle wheel 3 is determined as an obstacle, the first control unit 300 inserts the first front fork 120 and the first rear fork 130 again under the vehicle 2 in a state where the space between the first front fork 120 and the first rear fork 130 is further expanded.

When an obstacle other than the first vehicle wheel 3 is detected, the first control unit 300 may determine that the first robot 100 is unable to load the first vehicle wheel 3, and inform the user that the parking is not possible in the current environment. The first control unit 300 may flexibly communicate this information to the user, without any specific limitations. For example, the notification may be performed by a method of outputting information through a provided output unit such as a monitor or a method of transmitting a message to a portable terminal of the user.

As illustrated in FIGS. 2 and 6, the first rear obstacle recognition sensor 131 is disposed at the end of the first rear fork 130 to detect whether an obstacle is present on the movement path of the first rear fork 130 that is being inserted under the vehicle.

As illustrated in FIG. 6, similar to the first front obstacle recognition sensor 121, the first rear obstacle recognition sensor 131 may detect an obstacle within a two-dimensional fourth area S4.

The first rear obstacle recognition sensor 131 is different from the first front obstacle recognition sensor 121 only in terms of the installation position, but is controlled by the first control unit 300 in the same manner as that for the first front obstacle recognition sensor 121. Thus, the description of the first rear obstacle recognition sensor 131 will be substituted with the description of the first front obstacle recognition sensor 121.

Meanwhile, as illustrated in FIGS. 1 and 2, the vehicle parking robot 1 according to the embodiment of the present disclosure may further include the second robot 600, a second camera 700, a second control unit 800, a second front obstacle recognition sensor 621, and a second rear obstacle recognition sensor 631.

As illustrated in FIG. 2, the second robot 600 is provided to park the vehicle 2 by loading the pair of second vehicle wheels 4 in cooperation with the first robot 100.

As illustrated in FIG. 2, the second robot 600 is different from the first robot 100 only in terms of positions where the robots are disposed and positions of wheels that are loaded by the robots. The second robot 600 includes a second body 610, a second rail 611, a second front fork 620, a second rear fork 630, and a second electric wheel 640, which correspond to the first body 110, the first rail 111, the first front fork 120, the first rear fork 130, and the first electric wheel 140 of the first robot 100, respectively. Thus, the description of the components of the second robot 600 will be substituted with those for the first robot 100.

As illustrated in FIG. 2, a second front support member 623 and a second rear support member 633 correspond to the first front support member 123 and the first rear support member 133, respectively, described above, and the description of structures or functions thereof will be substituted with those for the first robot 100 within the overlapping scope.

Although not illustrated in the drawings, a second front auxiliary wheel and a second rear auxiliary wheel are disposed on the lower surfaces of the second front fork 620 and the second rear fork 630, respectively, to correspond to the first front auxiliary wheel 122 and the first auxiliary wheel 132 described above with reference to FIG. 6. Thus, the description of structures or functions thereof will be substituted with those for the first robot 100 within the overlapping scope.

The components of the first robot 100 and the components of the second robot 600 are discriminated using the terms “first” and “second,” and unless otherwise specified, the components having the same name excluding the terms “first” and “second” are considered as also having the same function or shape.

As illustrated in FIG. 2, the second robot 600 is provided independently from the first robot 100. The second robot 600 is controlled by the second control unit 800. That is, similar to the first control unit 300, the second control unit 800 controls the second front fork 620, the second rear fork 630, and the second electric wheel 640 of the second robot 600.

However, the second control unit 800 is dependent on the control of the first control unit 300. That is, the first control unit 300 is a primary control unit, and the second control unit 800 is a dependent control unit that is constrained by the control of the first control unit 300.

As illustrated in FIG. 1, the second control unit 800 may communicate with the first control unit 300. That is, the second control unit 800 receives a control signal from the first control unit 300 to control the second robot 600. There is no limitation on how the first control unit 300 communicates with the second control unit 800. For example, a wired or wireless communication method may be used. In the present embodiment, it is assumed that the first control unit 300 and the second control unit 800 are connected wirelessly, in order to enable the free movement of the second robot 600.

As illustrated in FIG. 4, when the second robot 600 is provided, the first control unit 300 further identifies the second vehicle wheel 4 from the first image information. The first control unit 300 identifies the right surfaces of the first vehicle wheel 3 and the second vehicle wheel 4, and calculates the distance between the first vehicle wheel 3 and the second vehicle wheel 4.

The first control unit 300 calculates a wheelbase as the distance between the first vehicle wheel 3 and the second vehicle wheel 4, more specifically, first distance information d2 between the first rotation axis C1 of the first vehicle wheel 3 and the second rotation axis C2 of the second vehicle wheel 4.

When the first control unit 300 transmits the wheelbase information of the vehicle 2 to the second control unit 800, the second control unit 800 adjusts the distance d1 between the first robot 100 and the second robot 600 based on the wheelbase information, and positions the second robot 600 on the right side of the second vehicle wheel 4, as illustrated in FIG. 3. That is, the second control unit 800 controls the second robot 600 based on the first distance information d2 received from the first control unit 300.

At this time, the first control unit 300 transmits a signal to the second control unit 800 such that the first front fork 120 and the first rear fork 130 of the first robot 100 and the second front fork 620 and the second rear fork 630 of the second robot 600 move toward the underneath of the vehicle 2. At this time, the first robot 100 and the second robot 600 may move together or sequentially toward the underneath of the vehicle 2.

The second control unit 800 controls the second front fork 620 and the second rear fork 630 to load the second vehicle wheel 4 on the second front fork 620 and the second rear fork 630. The description in this regard will be substituted with the description of the first front fork 120 and the first rear fork 130.

Meanwhile, as illustrated in FIG. 3, the second camera 700 is disposed on the left surface of the second body 610 to face the right surface of the second vehicle wheel 4. The second camera 700 generates data by capturing visual information within the second area S2. Similar to the first camera 200, the type of second camera 700 is not limited.

Similar to the first camera 200, the second camera 700 captures the image of the second area S2 to collect the second image information, and transmits the second image information to the second control unit 800. At this time, the second control unit 800 may adjust the spacing between the second camera 700 and the vehicle 2 to include the first vehicle wheel 3 and the second vehicle wheel 4 within the second area S2.

As illustrated in FIG. 4, the second control unit 800 identifies the first vehicle wheel 3 and the second vehicle wheel 4 from the second image information collected by the second camera 700. Similar to the first control unit 300, the second control unit 800 measures a wheelbase as second distance information d3 between the first vehicle wheel 3 and the second vehicle wheel 4.

As illustrated in FIG. 4, the first distance information d2 and the second distance information d3 are obtained by extracting the same information from the first image information and the second image information, respectively.

The second control unit 800 transmits the second distance information d3 to the first control unit 300, and the first control unit 300 compares the first distance information d2 and the second distance information d3, to improve the reliability of the wheelbase value.

That is, when the first distance information d2 does not match the second distance information d3, as the wheelbase value may be unreliable, the first control unit 300 prevents the first robot 100 and the second robot 600 from moving toward the underneath of the vehicle 2.

In this case, the first control unit 300 may re-measure the first distance information d2 and the second distance information d3 through the first camera 200 and the second camera 700, and compare the information. When the first distance information d2 and the second distance information d3 do not match consistently, the first control unit 300 may alert the user that the parking is not possible in the current environment.

Meanwhile, as illustrated in FIG. 1, the vehicle parking robot 1 according to the embodiment of the present disclosure may further include a host control unit 900.

The host control unit 900 is provided separately from the first robot 100 and the second robot 600. The host control unit 900 may conduct a wired or wireless communication with the first control unit 300. The host control unit 900 stores the wheelbase information between the first vehicle wheel 3 and the second vehicle wheel 4 of the vehicle 2 to be parked. At this time, the wheelbase information stored in the host control unit 900 is referred to as third distance information.

There are no limitations on how the host control unit 900 can obtain the third distance information. For example, the third distance information may be pre-registered as part of the vehicle 2's information, or may be derived from image information captured by a separate camera when the vehicle 2 is positioned in a specific station.

The first control unit 300 may compare the first distance information d2 measured from the first image information with the third distance information, to improve the reliability of the wheelbase information.

When the first distance information d2 and the third distance information do not match, as the wheelbase value may be unreliable, the first control unit 300 prevents the first robot 100 and the second robot 600 from moving toward the underneath of the vehicle 2.

In this case, the first control unit 300 may re-measure the first distance information d2 through the first camera 200, and compare the re-measured first distance information d2 with the third distance information. When the first distance information d2 and the third distance information do not match consistently, the first control unit 300 may alert the user that the parking is not possible in the current environment.

The first control unit 300 may compare the first distance information d2 with each of the second distance information d3 and the third distance information, to further improve the reliability of the wheelbase information. As a result, it is possible to more reliably prevent collisions between the first robot 100 and the second robot 600, which are separately controlled, and the vehicle 2.

Meanwhile, when the first distance information d2 matches with the second distance information d3, but not with the third distance information, the first control unit 300 may rely more on the second distance information d3, and may insert the first robot 100 and the second robot 600 under the vehicle 2. That is, the third distance information may be used as supplemental information.

The host control unit 900 may also be connected to the second control unit 800. Further, similar to the first control unit 300, the second control unit 800 may compare the first distance information d2 and the second distance information d3, and may further compare the first distance information d2 and the third distance information. In this case, the reliability of the wheelbase information may be further improved.

Meanwhile, the second front obstacle recognition sensor 621 and the second rear obstacle recognition sensor 631 may be provided at the front ends of the second front fork 620 and the second rear fork 630, respectively. The second front obstacle recognition sensor 621 and the second rear obstacle recognition sensor 631 correspond to the first front obstacle recognition sensor 121 and the first rear obstacle recognition sensor 131, respectively, and have the same functions as those thereof. Thus, the description of the second front obstacle recognition sensor 621 and the second rear obstacle recognition sensor 631 will be substituted with the description of the first front obstacle recognition sensor 121 and the first rear obstacle recognition sensor 131.

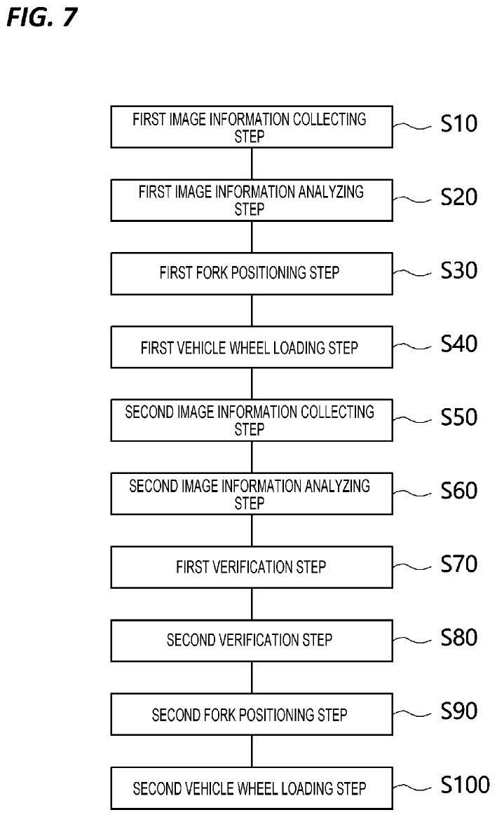

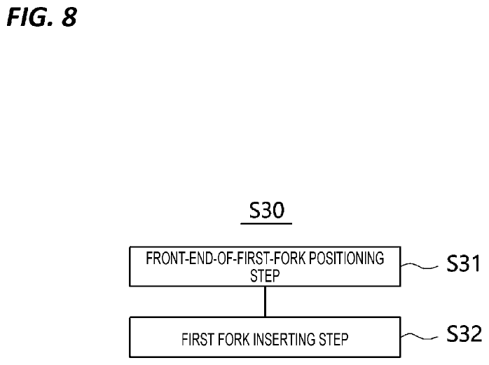

FIG. 7 is a flowchart of a vehicle parking method according to an embodiment of the present disclosure. FIG. 8 is a flowchart of a first fork positioning step of the vehicle parking method according to the embodiment of the present disclosure.

The vehicle parking method according to the embodiment of the present disclosure relates to moving the vehicle 2 to a specific parking space by using the vehicle parking robot as described above. The specific description of each component of the vehicle parking robot will be substituted with the description of the vehicle parking robot 1 described above.

As illustrated in FIG. 7, the vehicle parking method according to the embodiment of the present disclosure includes a first image information collecting step S10, a first image information analyzing step S20, a first fork positioning step S30, a first vehicle wheel loading step S40, a second fork positioning step S90, and a second vehicle wheel loading step S100.

In the first image information collecting step S10, the first camera 200 captures the image of the first vehicle wheel 3 to collect the first image information. In the first image information collecting step S10, the first camera 200 may capture the image of the first vehicle wheel 3 together with the second vehicle wheel 4 to collect the first image information.

In the first image information collecting step S10, when the first control unit 300 is unable to identify the first vehicle wheel 3 and the second vehicle wheel 4 from the first image information, the first control unit 300 controls the first electric wheels 140 to move the first camera 200 from the vehicle 2 by a predetermined distance, and the first camera 200 re-captures the image of the first vehicle wheel 3 and the second vehicle wheel 4.

Accordingly, the first control unit 300 may collect the first image information including the shape information of the first vehicle wheel 3 and the second vehicle wheel 4.

In the first image information analyzing step S20, the first control unit 300 identifies the first vehicle wheel 3 from the first image information. When the second robot 600 is provided, the first control unit 300 may additionally identify the second vehicle wheel 4 from the first image information. Hereinafter, descriptions will be made assuming that the second robot 600 will be provided.

In the first fork positioning step S30, the first control unit 300 positions the first front fork 120 at the front side of the first vehicle wheel 3 and positions the first rear fork 130 at the rear side of the first vehicle wheel 3, based on the position of the first vehicle wheel 3 identified from the first image information.

More specifically, the first fork positioning step S30 includes a front-end-of-first-fork positioning step S31 and a first fork inserting step S32.

As illustrated in FIG. 3, in the front-end-of-first-fork positioning step S31, the first control unit 300 controls the first electric wheels 140 to position the front end of the first front fork 120 and the front end of the first rear fork 130 close to the lateral surface of the first vehicle wheel 3.

When the positioning of the first front fork 120 and the first rear fork 130 is completed, the first control unit 300 moves the first front fork 120 and the first rear fork 130 in the extending direction of the rotation axis of the first vehicle wheel 3 to insert the first front fork 120 and the first rear fork 130 under the vehicle 2, in the first fork inserting step S32.

In the first vehicle wheel loading step S40, the first vehicle wheel 3 is lifted by the first front fork 120 and the first rear fork 130. More specifically, as the first front fork 120 and the first rear fork 130 move closer together about the first rotation axis C1 of the first vehicle wheel 3, the first vehicle wheel 3 is raised from the ground 5 and loaded on the first robot 100 while being supported on the first front fork 120 and the first rear fork 130.

In the second fork positioning step S90, the second control unit 800 positions the second front fork 620 at one side of the second vehicle wheel 4 and positions the second rear fork 630 at the other side of the second vehicle wheel 4, based on the first distance information d2 between the first vehicle wheel 3 and the second vehicle wheel 4 that are identified from the first image information received from the first control unit 300.

In this case, the second fork positioning step S90 includes a front-end-of-second-fork positioning step and a second fork inserting step, which correspond to the front-end-of-first-fork positioning step S31 and the first fork inserting step S32 described above. Thus, the description of the front-end-of-second-fork positioning step and the second fork inserting step will be substituted with the description of the front-end-of-first-fork positioning step S31 and the first fork inserting step S32.

In the second vehicle wheel loading step S100, the second vehicle wheel 4 is lifted by the second front fork 620 and the second rear fork 630. More specifically, as the second front fork 620 and the second rear fork 630 move closer together about the second rotation axis C2 of the second vehicle wheel 4, the second vehicle wheel 4 is raised from the ground 5 and loaded on the second robot 600 while being supported on the second front fork 620 and the second rear fork 630.

As illustrated in FIG. 7, the vehicle parking method according to the embodiment of the present disclosure may further include a second image information collecting step S50, a second image information analyzing step S60, a first verification step S70, and a second verification step S80, performed before the second fork positioning step S90.

In the second image information collecting step S50, the second camera 700 captures the image of the first vehicle wheel 3 and the second vehicle wheel 4 are to collect the second image information.

In the second image information analyzing step S60, the first vehicle wheel 3 and the second vehicle wheel 4 are identified from the second image information collected in the second image information collecting step S50.

In the first verification step S70, the second control unit 800 transmits, to the first control unit 300, the second distance information d3 between the first vehicle wheel 3 and the second vehicle wheel 4 that is calculated by identifying the first vehicle wheel 3 and the second vehicle wheel 4 from the second image information. Then, the first control unit 300 compares the second distance information d3 with the first distance information d2, and verifies whether the information match each other.

When the first distance information d2 matches the second distance information d3, the first control unit 300 controls the first robot 100, and the second control unit 800 controls the second robot 600, so that the first vehicle wheel 3 and the second vehicle wheel 4 may be loaded on the first robot 100 and the second robot 600, respectively.

Meanwhile, when the first distance information d2 does not match the second distance information d3, the loading operation is stopped, and the first control unit 300 may alert the user that the parking is not possible in the current environment, in various known ways.

In the second verification step S80, the first control unit 300 receives the third distance information between the first vehicle wheel 3 and the second vehicle wheel 4 from the host control unit 900, and compares the third distance information with the first distance information d2 to verify whether the information match each other.

Accordingly, when the first distance information d2 matches the third distance information, the first control unit 300 controls the first robot 100, and the second control unit 800 controls the second robot 600, so that the first vehicle wheel 3 and the second vehicle wheel 4 may be loaded on the first robot 100 and the second robot 600, respectively.

That is, when the first distance information d2 matches with the second distance information d3 and with the third distance information, the vehicle 2 is loaded on the first robot 100 and the second robot 600.

In order to prevent an occurrence of numbers of situations where the parking is not possible, when the first distance information d2 matches with the second distance information d3, but not with the third distance information, the first control unit 300 may determine the second distance information d3 reliable, and load the vehicle 2 on the first robot 100 and the second robot 600.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A vehicle parking robot comprising:
a first robot including a first body provided with a first rail that extends longitudinally, a first front fork coupled to the first rail and configured to move along the first rail and support a first side of a first vehicle wheel of a vehicle, the first vehicle wheel rotating about a first rotation axis, a first rear fork coupled to the first rail and configured to move along the first rail and support a second side of the first vehicle wheel, and a first electric wheel configured to provide a driving force;
a first camera disposed on the first body to face a lateral surface of the first vehicle wheel and configured to capture an image of the first vehicle wheel and collect first image information; and
a first controller configured to identify the first vehicle wheel from the first image information, and control the first front fork, the first rear fork, and the first electric wheel,
wherein the vehicle parking robot lifts the vehicle from a ground, and places the vehicle in a parking space.

2. The vehicle parking robot according to claim 1, wherein the first controller controls the first electric wheel to position the first front fork at the first side of the first vehicle wheel identified from the first image information, and the first rear fork at the second side of the first vehicle wheel.

3. The vehicle parking robot according to claim 2, wherein the first controller controls the first electric wheel to position a front end of the first front fork and a front end of the first rear fork at the lateral surface of the first vehicle wheel, and then to move the first front fork and the first rear fork in a first direction in which the first rotation axis of the first vehicle wheel extends, to insert the first front fork and the first rear fork under the vehicle.

4. The vehicle parking robot according to claim 1, further comprising:
a first front obstacle recognition sensor disposed at an end of the first front fork; and
a first rear obstacle recognition sensor disposed at an end of the first rear fork.

5. The vehicle parking robot according to claim 1, wherein
the vehicle further includes a second vehicle wheel configured to rotate about a second rotation axis parallel to the first rotation axis, and
the vehicle parking robot further comprises:
a second robot including a second body provided with a second rail that extends longitudinally, a second front fork coupled to the second rail and configured to move along the second rail and support a first side of the second vehicle wheel, a second rear fork coupled to the second rail and configured to move along the second rail and support a second side of the second vehicle wheel, and a second electric wheel disposed on the second body and configured to provide a driving force; and
a second controller configured to receive a control signal from the first controller to control the second front fork, the second rear fork, and the second electric wheel.

6. The vehicle parking robot according to claim 5, wherein
the first controller transmits first distance information between the first vehicle wheel and the second vehicle wheel to the second controller, the first distance information being calculated by further identifying the second vehicle wheel from the first image information, and
the second controller controls the second electric wheel based on the first distance information to position the second front fork at the first side of the second vehicle wheel identified from the first image information, and the second rear fork at the second side of the second vehicle wheel.

7. The vehicle parking robot according to claim 6, wherein when the first controller does not identify the first vehicle wheel and the second vehicle wheel from the first image information, the first controller controls the first electric wheel to move the first camera from the vehicle by a predetermined distance, and the first camera re-captures an image of the first vehicle wheel and the second vehicle wheel to collect the first image information.

8. The vehicle parking robot according to claim 6, wherein
the first controller controls the first electric wheel to position a front end of the first front fork and a front end of the first rear fork at the lateral surface of the first vehicle wheel, and then move the first front fork and the first rear fork in a first direction in which the first rotation axis extends, to insert the first front fork and the first rear fork under the vehicle, and
the second controller controls the second electric wheel to position a front end of the second front fork and a front end of the second rear fork at a lateral surface of the second vehicle wheel, and then move the second front fork and the second rear fork in a second direction in which the second rotation axis extends, to insert the second front fork and the second rear fork under the vehicle.

9. The vehicle parking robot according to claim 6, further comprising:
a second camera disposed on the second body to face a lateral surface of the second vehicle wheel, and configured to capture an image of the second vehicle wheel and collect second image information,
wherein the second controller transmits second distance information between the first vehicle wheel and the second vehicle wheel to the first controller, the second distance information being calculated by identifying the first vehicle wheel and the second vehicle wheel from the second image information, and
the first controller compares the first distance information and the second distance information to verify whether the first distance information matches the second distance information, and determines whether to load the vehicle.

10. The vehicle parking robot according to claim 9, further comprising:
a host controller configured to store third distance information between the first vehicle wheel and the second vehicle wheel of the vehicle, and communicate with the first controller.

11. The vehicle parking robot according to claim 10, wherein the first controller compares the first distance information with the third distance information to verify whether the first distance information matches the third distance information, and determines whether to load the vehicle, the first distance information being calculated by identifying the first vehicle wheel and the second vehicle wheel from the first image information.

12. The vehicle parking robot according to claim 11, wherein when the first distance information does not match the third distance information, the first controller further compares the first distance information with the second distance information to verify whether the first distance information matches the second distance information, and determines whether to load the vehicle.

13. A vehicle parking method comprising:
a vehicle parking robot providing step for providing a vehicle parking robot configured to lift a vehicle from a ground and place the vehicle in a parking space, the vehicle including a first vehicle wheel rotating about a first rotation axis and a second vehicle wheel rotating about a second rotation axis parallel to the first rotation axis;
a first image information collecting step for collecting first image information by capturing an image of the first vehicle wheel by a first camera;
a first image information analyzing step for identifying the first vehicle wheel from the first image information;
a first fork positioning step for positioning a first front fork at a first side of the first vehicle wheel and a first rear fork at a second side of the first vehicle wheel, by a first controller, based on a position of the first vehicle wheel identified from the first image information; and
a first vehicle wheel loading step for lifting the first vehicle wheel with the first front fork and the first rear fork.

14. The vehicle parking method according to claim 13, wherein the first fork positioning step includes:
a front-end-of-first-fork positioning step for controlling, by the first controller, a first electric wheel to position a front end of the first front fork and a front end of the first rear fork at a lateral surface of the first vehicle wheel; and
a first fork inserting step for moving, by the first controller, the first front fork and the first rear fork in a first direction in which the first rotation axis of the first vehicle wheel extends, to insert the first front fork and the first rear fork under the vehicle.

15. The vehicle parking method according to claim 13, wherein in the first vehicle wheel loading step, the first front fork and the first rear fork move closer together about the first rotation axis of the first vehicle to lift the first vehicle wheel from the ground.

16. The vehicle parking method according to claim 13, wherein
in the first image information collecting step, the first camera captures an image of the first vehicle wheel and the second vehicle wheel to collect the first image information,
in the first image information analyzing step, the first vehicle wheel and the second vehicle wheel are identified from the first image information, and
the vehicle parking method further comprises:
a second fork positioning step for positioning, by a second controller, a second front fork at a first side of the second vehicle wheel and a second rear fork at a second side of the second vehicle wheel, based on first distance information between the first vehicle wheel and the second vehicle wheel that are identified from the first image information received from the first controller; and
a second vehicle wheel loading step for lifting the second vehicle wheel with the second front fork and the second rear fork.

17. The vehicle parking method according to claim 16, wherein in the first image information collecting step, when the first controller does not identify the first vehicle wheel and the second vehicle wheel from the first image information, the first controller controls a first electric wheel to move the first camera from the vehicle by a predetermined distance, and the first camera re-captures an image of the first vehicle wheel and the second vehicle wheel to collect the first image information.

18. The vehicle parking method according to claim 16, further comprising:
prior to the second fork positioning step,
a second image information collecting step for collecting second image information by capturing an image of the first vehicle wheel and the second vehicle wheel by a second camera;
a second image information analyzing step for identifying the first vehicle wheel and the second vehicle wheel from the second image information; and
a first verification step for transmitting, by the second controller, second distance information between the first vehicle wheel and the second vehicle wheel to the first controller, the second distance information being calculated by identifying the first vehicle wheel and the second vehicle wheel from the second image information, and comparing, by the first controller, the first distance information and the second distance information to verify whether the first distance information matches the second distance information,
wherein in the second fork positioning step, when the first distance information matches the second distance information, the second controller receives a control signal from the first controller to control the second front fork and the second rear fork.

19. The vehicle parking method according to claim 18, further comprising:
prior to the second fork positioning step,
a second verification step for receiving, by the first controller, third distance information between the first vehicle wheel and the second vehicle wheel from a host controller, and comparing, by the first controller, the third distance information with the first distance information to verify whether the first distance information matches the third distance information,
wherein in the second fork positioning step, when determined in the second verification step that the first distance information matches the third distance information, the second controller receives a control signal from the first controller to control the second front fork and the second rear fork.

20. The vehicle parking method according to claim 19, wherein in the second fork positioning step, when determined in the second verification step that the first distance information matches with the second distance information, but not with the third distance information, the second controller receives a control signal from the first controller to control the second front fork and the second rear fork.
